(19) United States
(12) Patent Application Publication
(10) Pub. No.: US 2013/0290242 A1
(43) Pub. Date: Oct. 31, 2013

(54) TIME SERIES DATA PROCESSING DEVICE AND METHOD THEREFOR

(71) Applicant: Naohiro Suzuki, Yokohama (JP)

(72) Inventor: Naohiro Suzuki, Yokohama (JP)

(21) Appl. No.: 13/813,574

(22) PCT Filed: Aug. 11, 2010
(86) PCT No.: PCT/JP2010/005045

§ 371 Date: Apr. 11, 2013

(51) Int. Cl. G06F 17/30

(52) U.S. Cl. CPC G06F 17/30557
USPC 707/600

(57) ABSTRACT

A data accumulation unit selects, upon data accumulation, time series data relating to a predicted number of vibrations and an actual number of vibrations as combinations of time series data, which become the analysis targets and are generated in the same cycle, among time series data from a time series data source, aggregates the selected combinations of time series data on an hourly basis, and accumulates the aggregated plural sets of time series data in an aggregated data table by associating them with an attribute (the number of vibrations); and upon data analysis, a data analysis unit accesses the aggregated data table based on the attribute, extracts the combinations of the time series data relating to the predicted number of vibrations and the actual number of vibrations as time series data to be used for the analysis and calculates the number of divergence vibrations.

### TECHNICAL FIELD

The present invention relates to a time series data processing unit and method for processing time series data generated by, for example, various sensors.

### BACKGROUND ART

Conventionally, with computer systems and the like, data detected by various sensors are fetched as time series data and, for example, analysis and control processing is executed by using the fetched time series data. For example, a technique that collects and analyzes a plurality of pieces of time series data, which are fetched at various places, is suggested (see Patent Literature 1).

Patent Literature 1 discloses a technique used when analyzing a plurality of pieces of time series data to: complement missing data according to sampling cycles of the plurality of pieces of time series data in consideration of the fact that each piece of data has a different sampling cycle; and accumulate the complemented data. Specifically speaking, if the time series data are sampled in a 1-second cycle or a 2-second cycle, the time series data in the 2-second cycle are complemented based on the time series data in the 1-second cycle, thereby accumulating each piece of time series data.

Furthermore, when efficiently displaying long-term plant data at high speeds, a technique that efficiently searches a large amount of long-term data generated at a plant, monitors tendencies of the plant data, and monitors abnormal values is suggested (see Patent Literature 2).

Patent Literature 2 discloses a technique that fetches the plant data in a specified data fetching cycle, writes them to a plant data table, fetches the plant data in a data record cycle longer than the data fetching cycle, collects them in each data record cycle, stores them in a plant data history information table, creates long-term search history information including a maximum value, minimum value, and average value of the plant data for each piece of plant data history information, stores it in a long-term search history information table, performs a data search of any one of the tables when displaying the data, and displays the content of the searched data as a graph on a display device.

### CITATION LIST

### Patent Literature

Patent Literature 1: Japanese Patent Application Laid-Open (Kokai) Publication No. 2003-44518
Patent Literature 2: Japanese Patent Application Laid-Open (Kokai) Publication No. 2010-49533

### DISCLOSURE OF INVENTION

### Problems to be Solved by the Invention

Regarding Patent Literature 1, the time series data are complemented in accordance with a shorter sampling cycle. So, even if each piece of data has a different sampling cycle, the time series data can be analyzed accurately. However, since the time series data are accumulated in accordance with a shorter cycle upon accumulation of the time series data, an amount of accumulated data increases and it becomes difficult to efficiently accumulate the plurality of pieces of time series data.

Furthermore, the technique of Patent Literature 2 calculates the average value, the maximum value, or the minimum value of each piece of time series data in each constant cycle. So, if it is necessary to perform analysis by using the plurality of pieces of time series data, for example, if operations to calculate differences between the plurality of pieces of time series data (such as a difference between the maximum value and the minimum value) are required, it is necessary to access individual pieces of the time series data and calculate the values of each piece of time series data. Therefore, the plurality of pieces of time series data cannot be accessed efficiently.

The present invention was devised in light of the above-described problems of the conventional technology and it is an object of the invention to provide a time series data processing unit and method capable of efficiently accessing the plurality of pieces of time series data which are analysis targets.

### Means for Solving the Problems

In order to achieve the above-described object, the present invention is characterized in that: upon data accumulation, a plurality of pieces of time series data which are analysis targets are combined, the combined plural pieces of time series data are accumulated in a storage unit by associating them with their attribute; and upon data analysis, the combined plural pieces of time series data are extracted, as time series data to be used for the analysis, based on the attributes from the storage unit.

### Advantageous Effects of Invention

According to the present invention, the plurality of pieces of time series data to be used for analysis can be accessed and analyzed efficiently.

### BRIEF DESCRIPTION OF DRAWINGS

FIG. 1 is a block diagram showing the overall configuration of a computer system to which the present invention is applied.

FIG. 2 is a structure diagram of a time series data management table.

FIG. 3 is a structure diagram of attribute-aggregated information.

FIG. 4 is a structure diagram of an attribute buffer.

FIG. 5 is a structure diagram of time-aggregated information.

FIG. 6 is a structure diagram of a time buffer.

FIG. 7 is a structure diagram of an aggregated data table.

FIG. 8 is a structure diagram of an analysis query.

FIG. 9 is a flowchart for explaining time series data accumulation processing.

FIG. 10 is a flowchart for explaining time series data analysis processing.

FIG. 11 is a flowchart for explaining processing for creating lists of an analysis target ID, a search target ID, an acquisition target ID, and an acquisition target aggregation ID.

FIG. 12 is a flowchart for explaining data acquisition processing.

FIG. 13 is a flowchart for explaining data extraction and analysis processing according to a condition and an attribute.

FIG. 14 is a block diagram showing an overall configuration diagram of a computer system according to a second embodiment.

FIG. 15 is a structure diagram of cycle-aggregated information.

FIG. 16 is a structure diagram of a cycle buffer.

FIG. 17 is a structure diagram of attribute-aggregated information.

FIG. 18 is a structure diagram of an attribute buffer.

FIG. 19 is a structure diagram of time-aggregated information.

FIG. 20 is a structure diagram of a time buffer.

FIG. 21 is a structure diagram of an aggregated data table.

FIG. 22 is a structure diagram of an analysis query.

FIG. 23 is a flowchart for explaining time series data accumulation processing.

FIG. 24 is a flowchart for explaining time series data analysis processing.

FIG. 25 is a flowchart for explaining data extraction and analysis processing according to a condition, an attribute, and a cycle.

### DESCRIPTION OF EMBODIMENTS

### Embodiment 1

This embodiment is designed so that: upon data accumulation, combinations of time series data generated in the same cycle (time series data relating to a predicted number of vibrations and an actual number of vibrations) are selected as combinations of a plurality of pieces of time series data, which become analysis targets, a plurality of sets of the selected combinations of the time series data are aggregated on a set time basis, and the plurality of sets of the aggregated time series data are accumulated in a storage unit by associating with an attribute (the number of vibrations); and upon data analysis, the combinations of time series data generated in the same cycle (time series data relating to the predicted number of vibrations and the actual number of vibrations) are extracted, as time series data to be used for the analysis, from the storage unit.

An embodiment of the present invention will be explained below based on drawings.

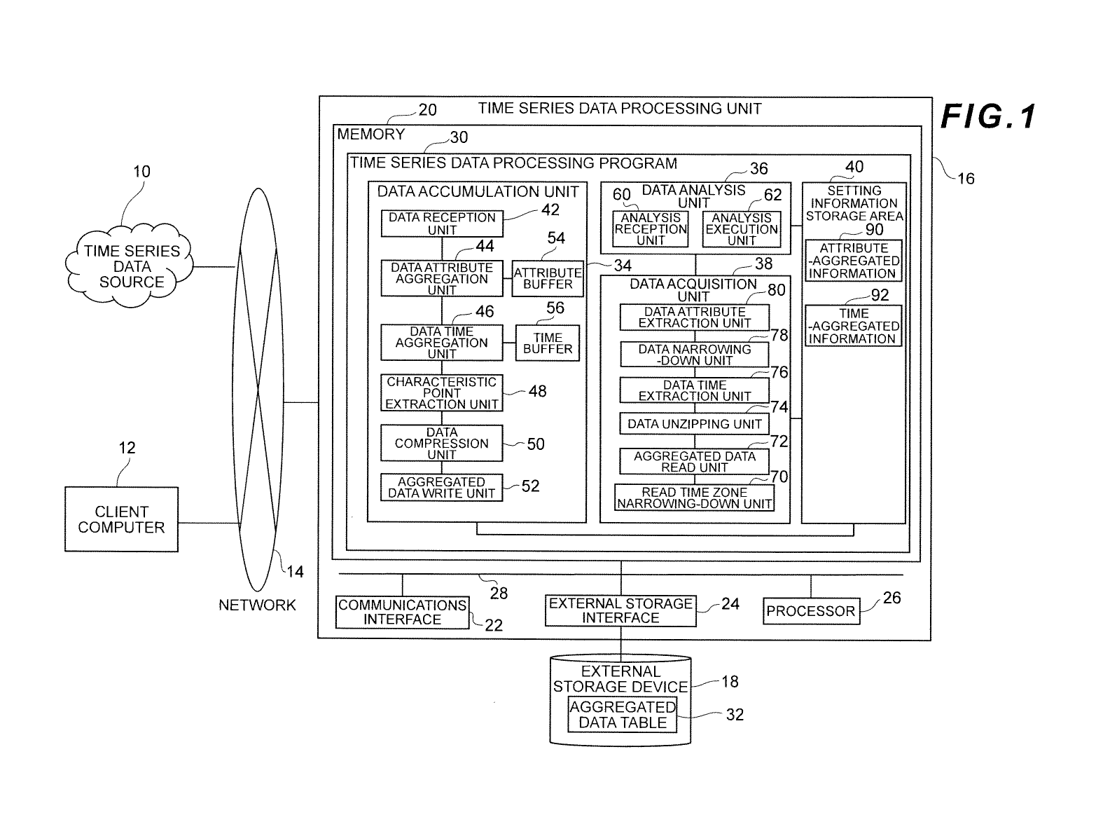

FIG. 1 is a block configuration diagram of a computer system to which the present invention is applied. Referring to FIG. 1, the computer system is configured by including a time series data source 10, a client computer 12, a network 14, a time series data processing unit 16, and an external storage device 18. The time series data source 10, the client computer 12, and the time series data processing unit 16 are connected to each other via the network 14; and the time series data processing unit 16 is connected to the external storage device 18.

The time series data source 10 includes, for example, various sensors such as sensors for detecting temperatures, humidity, voltages, electric currents, power generation, power consumption, and an actual number of turbine vibrations, or a predicted-number-of-vibrations generating vibration machine for generating, for example, a predicted value of turbine vibrations; and is configured as a time series data generation source that outputs output signals from the various sensors and the predicted-number-of-vibrations generating vibration machine as time series data to the network 14 in chronological order.

The client computer 12 has, for example, a processor, a memory, an input/output device, a storage device, and a display device; issues an analysis query as an analysis request to the network 14 and receives data from the time series data processing unit 16 via the network 14, and stores the received data as result data in the storage device.

The time series data processing unit 16 is constituted from a memory 20, a communications interface 22, an external storage interface 24, and a processor 26; the memory 20, the communications interface 22, the external storage interface 24, and the processor 26 are connected to each other via an internal network 28; the communications interface 22 is connected to the network 14; and the external storage interface 24 as a storage unit is connected to the external storage device 18. Incidentally, the following configuration can be employed so that a storage device as a storage unit instead of the external storage device 18 may be located in the time series data processing unit 16 and this storage device may be connected to the internal network 28.

The processor 26 supervises and controls the entire time series data processing unit 16 and executes various processing in accordance with a time series data processing program 30 stored in the memory 20.

Under this circumstance, the processor 26 functions as a data processing unit for sequentially inputting and processing time series data, which are output from the time series data source 10; and also functions as a data acquisition analysis unit for accessing an aggregated data table 32 stored in the external storage device 18, obtaining data from the aggregated data table 32, and analyzing the obtained data.

The time series data processing program 30 is constituted from a data accumulation unit 34, a data analysis unit 36, a data acquisition unit 38, and a setting information storage area 40.

The data accumulation unit 34 functions as a data processing unit and is constituted from a data reception unit 42, a data attribute aggregation unit 44, a data time aggregation unit 46, a characteristic point extraction unit 48, a data compression unit 50, an aggregated data write unit 52, an attribute buffer 54, and a time buffer 56.

The data analysis unit 36 is composed of an analysis reception unit 60 and an analysis execution unit 62.

The data acquisition unit 38 is constituted from a read time zone narrowing-down unit 70, an aggregated data read unit 72, a data unzipping unit 74, a data time extraction unit 76, a data narrowing-down unit 78, and a data attribute extraction unit 80. Under this circumstance, the data analysis unit 36 and the data acquisition unit 38 function as a data acquisition analysis unit.

The setting information storage area 40 stores attribute-aggregated information 90 and time-aggregated information 92.

If the time series data which are output from the time series data source 10 are input to the time series data processing unit 16 via the network 14 and the communications interface 22, the data reception unit 42 for the data accumulation unit 34 sequentially accepts the input time series data in chronological order. When receiving time series data relating to a predicted number of vibrations and time series data relating to an actual number of vibrations as time series data generated in the same cycle, this data reception unit 42 outputs each pieces of the time series data to the data attribute aggregation unit 44.

The data attribute aggregation unit 44: combines a plurality of pieces of time series data, which become analysis targets, that is, a plurality of pieces of time series data generated in the same cycle, among the time series data which were input; combines the combined plural pieces of time series data, for example, the time series data relating to the predicted number of vibrations and the actual number of vibrations; aggregates the combined plural pieces of time series data by associating them with a mutually related attribute, for example, the number of vibrations (hereinafter sometimes referred to as attribute-aggregated); and accumulates the aggregated time series data as attribute-aggregated data in the attribute buffer 54 and outputs them to the data time aggregation unit 46.

The data time aggregation unit 46 gathers and collects the attribute-aggregated data, which have been input, only for a set time period (set time) and processes them as time-aggregated data. For example, the data time aggregation unit 46 aggregates the attribute-aggregated data, which have been input, on an hourly basis, accumulates them as time-aggregated data in the time buffer 56, and outputs them to the characteristic point extraction unit 48.

Specifically speaking, if the time series data, which are the analysis targets and are a plurality of pieces of time series data generated in the same cycle, are combined, the data attribute aggregation unit 44 selects one set of the combinations of the time series data each time, gathers and aggregates each selected set of the time series data on an hourly basis, which is the set time, and accumulates the aggregated plural sets of combinations of the time series data as the time-aggregated data in the time buffer 56.

The characteristic point extraction unit 48 extracts characteristic points from the time-aggregated data, which have been input, and outputs the extracted characteristic points such as a maximum predicted value, a minimum predicted value, a maximum actual value, and a minimum actual value as well as the input time-aggregated data to the data compression unit 50.

The data compression unit 50 compresses the time-aggregated data, which have been output from the characteristic point extraction unit 48, and outputs the compressed data and the characteristic points, which have been output from the characteristic point extraction unit 48, to the aggregated data write unit 52.

The aggregated data write unit 52 writes the data, which have been output from the data compression unit 50, as aggregated data to the aggregated data table 32 of the external storage device 18.

When an analysis query issued from the client computer 12 is input via the network 14 and the communications interface 22, the analysis reception unit 60 for the data analysis unit 36 receives the analysis query from the client computer 12 and outputs the received analysis query to the data acquisition unit 38. The analysis execution unit 62 executes analysis as specified by the analysis query based on the processing results of the data acquisition unit 38.

The read time zone narrowing-down unit 70 for the data acquisition unit 38 interprets the analysis query from the analysis reception unit 60, obtains a read time zone and search conditions specified by the analysis query, narrows down the read time zone based on the characteristic points of the read time zone obtained from the aggregated data table 32, and outputs it to the aggregated data read unit 72.

The aggregated data read unit 72 searches the aggregated data table 32 based on the read time zone narrowed down by the read time zone narrowing-down unit 70 and outputs data belonging to a data aggregation time zone stored in the aggregated data table 32 (data including, for example, the aggregation ID, the characteristic points, and the time-aggregated data) to the data unzipping unit 74.

The data unzipping unit 74 unzips the time-aggregated data output from the aggregated data read unit 72 and outputs the unzipped time-aggregated data to the data time extraction unit 76.

The data time extraction unit 76 extracts time-aggregated data of a read time zone from the time-aggregated data unzipped by the data unzipping unit 74, processes the extracted time-aggregated data as attribute-aggregated data, and outputs the attribute-aggregated data to the data narrowing-down unit 78.

The data narrowing-down unit 78 narrows down and extracts the attribute-aggregated data, which satisfy the search conditions specified by the analysis query, from the attribute-aggregated data processed by the data time extraction unit 76, and outputs the narrowed-down attribute-aggregated data to the data attribute extraction unit 80.

The data attribute extraction unit 80 extracts a plurality of pieces of time series data (time series data relating to the predicted number of vibrations and the actual number of vibrations), which have the analysis target attribute (the number of vibrations), for each same cycle from the attribute-aggregated data narrowed down by the data narrowing-down unit 78 and outputs the plural pieces of the extracted time series data to the analysis execution unit 62.

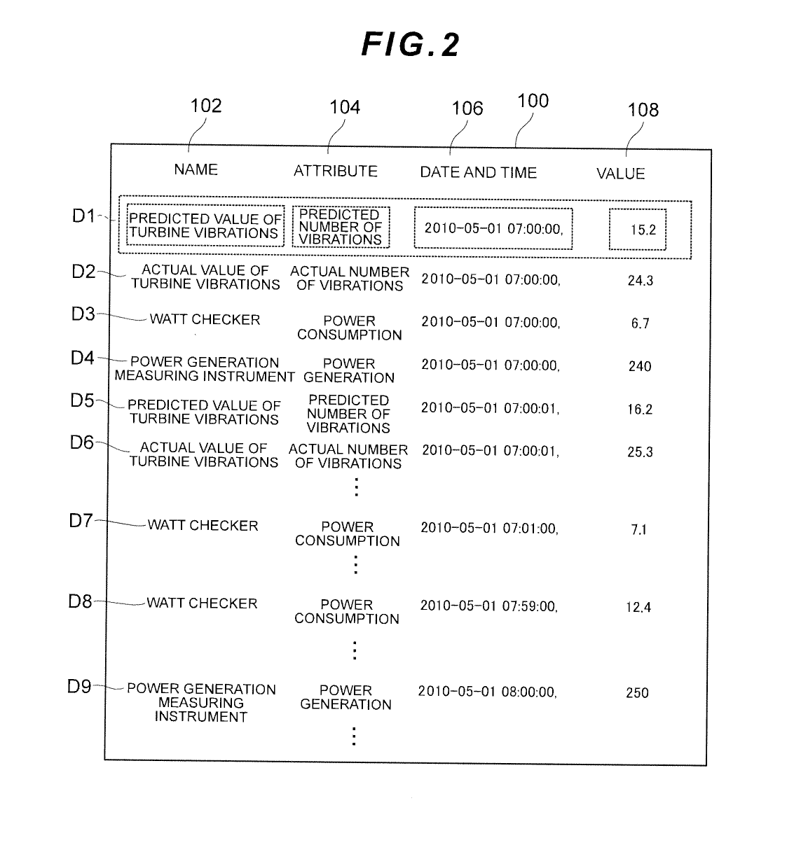

Next, FIG. 2 shows the structure of a time series data management table.

Referring to FIG. 2, a time series data management table 100 is a table stored in, for example, the memory 20 for the time series data processing unit 16 and is constituted from a name 102, an attribute 104, a date and time 106, and a value 108. This time series data management table 100 sequentially stores information about time series data generated from the time series data source 10.

For example, time series data D1 is managed as data regarding which the name 102 is a “predicted value of turbine vibrations,” the attribute 104 is a “predicted number of vibrations,” the date and time 106 is “2010-05-01 07:00:00,” and the value 108 is “15.2”. Time series data D2 is managed as data regarding which the name 102 is an “actual value of turbine vibrations,” the attribute 104 is an “actual number of vibrations,” the date and time 106 is “2010-05-01 07:00:00,” and the value 108 is “24.3”.

Time series data D3 is managed as data regarding which the name 102 is a “watt checker,” the attribute 104 is “power consumption,” the date and time 106 is “2010-05-01 07:00:00,” and the value 108 is “6.7”; and time series data D4 is managed as data regarding which the name 104 is a “power generation measuring instrument,” the attribute 104 is “power generation,” the date and time 106 is “2010-05-01 07:00:00,” and the value 108 is “240.”

The time series data D1, D2 are time series data generated in the same cycle; and in the next generation cycle, they will be managed as time series data D5, D6.

The time series data D3, D4 are time series data generated in mutually different cycles. The time series data D3 is generated every minute; and in the next generation cycle, it will be managed as time series data D7. The time series data D4 is time series data generated in a one-hour cycle; and in the next generation cycle, it will be managed as time series data D9.

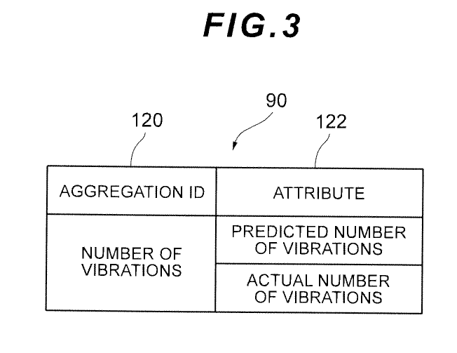

Next, FIG. 3 shows the structure of attribute-aggregated information 90 stored in the setting information storage area 40.

Referring to FIG. 3, the attribute-aggregated information 90 is constituted from an aggregation ID 120 and an attribute 122. The attribute 122 stores, for example, the “predicted number of vibrations” as an attribute of time series data relating to the predicted value of turbine vibrations and the “actual number of vibrations” indicating the attribute of the actual value of turbine vibrations among the plurality of pieces of time series data which become the analysis targets. The aggregation ID 120 stores, for example, the “number of vibrations” which is an attribute indicated by, and mutually related to, the predicted number of vibrations and the actual number of vibrations.

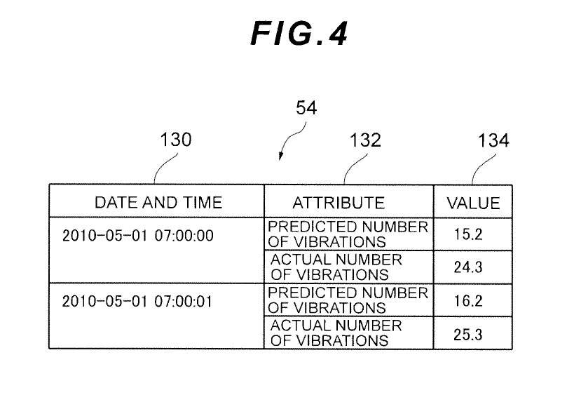

Next, FIG. 4 shows the structure of the attribute buffer 54.

An information storage area of the attribute buffer 54 is configured in a table format and the table is constituted from a date and time field 130, an attribute field 132, and a value field 134. Each entry of the date and time field 130 stores information about the date and time when a plurality of pieces of time series data which become the analysis targets are obtained.

Each entry of the attribute field 132 stores, for example, the “predicted number of vibrations” and the “actual number of vibrations” as information about the attribute of the plurality of pieces of time series data which become the analysis targets.

Each entry of the value field 134 stores information about the value of each piece of time series data, for example, “15.2” as the value of the time series data relating to the predicted number of vibrations and “24.3” as the value of the time series data relating to the actual number of vibrations.

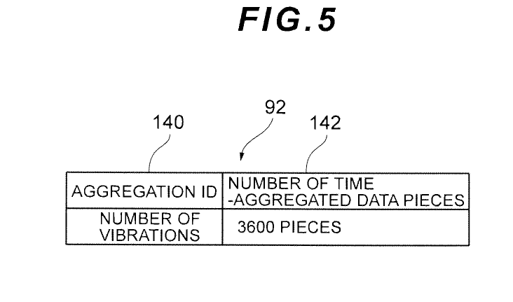

Next, FIG. 5 shows the structure of the time-aggregated information 92 stored in the setting information storage area 40.

The time-aggregated information 92 is constituted from an aggregation ID 140 and the number of time-aggregated data pieces 42. The aggregation ID 140 stores, for example, the “number of vibrations” which is an attribute indicated by, and mutually related to, the predicted number of vibrations and the actual number of vibrations. The number of time-aggregated data pieces 142 stores, for example, information indicating “3600 pieces” as the number of pieces of time series data to be accumulated for one hour.

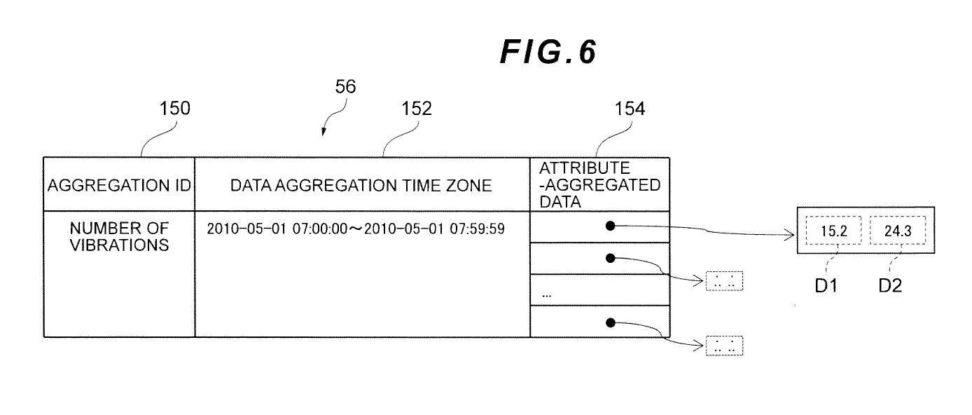

Next, FIG. 6 shows the structure of the time buffer 56.

An information storage area of the time buffer 56 is configured in a table format and the table is constituted from an aggregation ID field 150, a data aggregation time zone field 152, and an attribute-aggregated data field 154.

An entry of the aggregation ID field 150 stores, for example, information of the “number of vibrations.” An entry of the data aggregation time zone field 152 stores information about a time zone during which the time series data are aggregated.

Each entry of the attribute-aggregated data field 154 stores a plurality of pieces of time series data which become the analysis targets, for example, a combination of the time series data D1 and the time series data D2 by associating the combined time series data D1, D2 with the “number of vibrations” which is the aggregation ID.

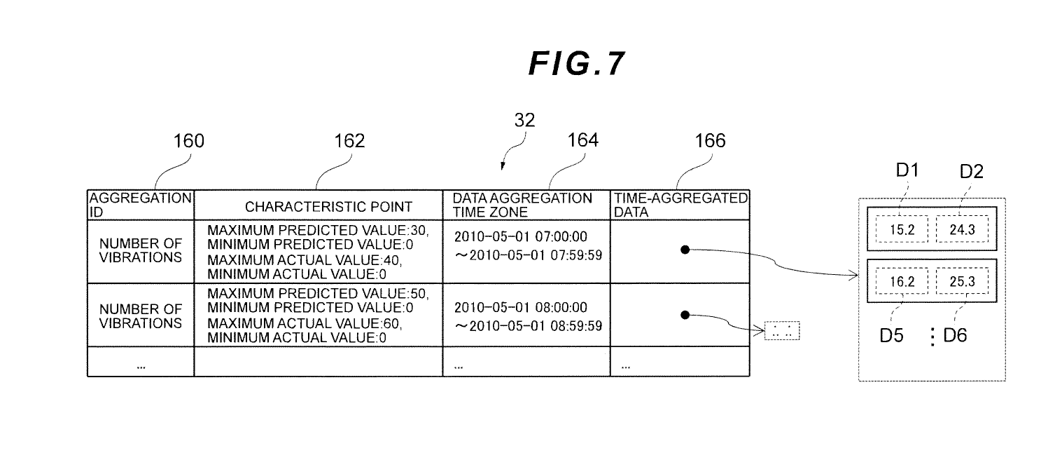

Next, FIG. 7 shows the structure of the aggregated data table 32 stored in the external storage device 18.

Referring to FIG. 7, the aggregated data table 32 is constituted from an aggregation ID field 160, a characteristic point field 162, a data aggregation time zone field 164, and a time-aggregated data field 166.

For example, each entry of the aggregation ID field 160 stores information of the “number of vibrations” which is an attribute aggregating the attribute indicated by the predicted number of vibrations and the actual number of vibrations.

Each entry of the characteristic point field 162 stores information about characteristic points of the time series data accumulated for one hour among the plurality of pieces of time series data which have been input. For example, a maximum value of the predicted number of vibrations is stored as a “maximum predicted value: 30”; a minimum value of the predicted number of vibrations is stored as a “minimum predicted value: 0”; a maximum value of the actual number of vibrations is stored as a “maximum actual value: 40”; and a minimum value of the actual number of vibrations is stored as a “minimum actual value: 0”.

The data aggregation time zone field 164 stores information about a data aggregation time zone, during which each piece of time series data was gathered as the time-aggregated data, as a numerical value together with information indicating the relevant date.

Each entry of the time-aggregated data field 166 stores data relating to the time-aggregated data which were aggregated on an hourly basis. Under this circumstance, the time series data D1, D2 are combined, the time series data D5, D6 are combined, and the respectively combined time series data D1, D2, D5, D6 are stored by associating them with the “number of vibrations” which is the aggregation ID. Furthermore, each entry stores the combined time series data for one hour.

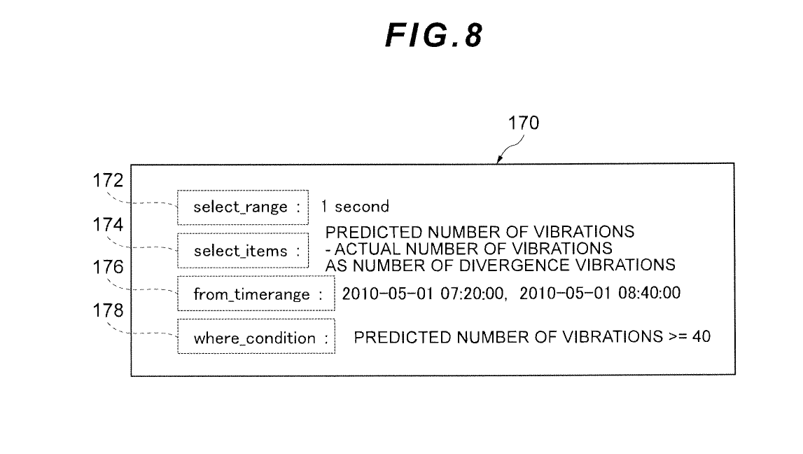

Next, FIG. 8 shows the structure regarding an analysis query.

Referring to FIG. 8, an analysis query 170 is constituted from a selected range (select_range) 172, selected items (select_items) 174, a data acquisition target time zone (from_timerange) 176, and a search condition (where_condition) 178.

The selected range 172 stores, for example, “1 second” as timing of processing by the data analysis unit 36. The selected items 174 store, for example, “Predicted Frequency—Actual Frequency AS Divergence Frequency” as the analysis target ID for the analysis execution unit 62 to perform analysis.

The data acquisition target time zone 176 stores, for example, “2010-05-01 07:20:00 to 2010-05-01 08:40:00” as information about the data acquisition target time zone used by the analysis execution unit 62 when executing the analysis.

The search condition 178 stores information of, for example, the “predicted number of vibrations >=40” as a condition to become the search target ID.

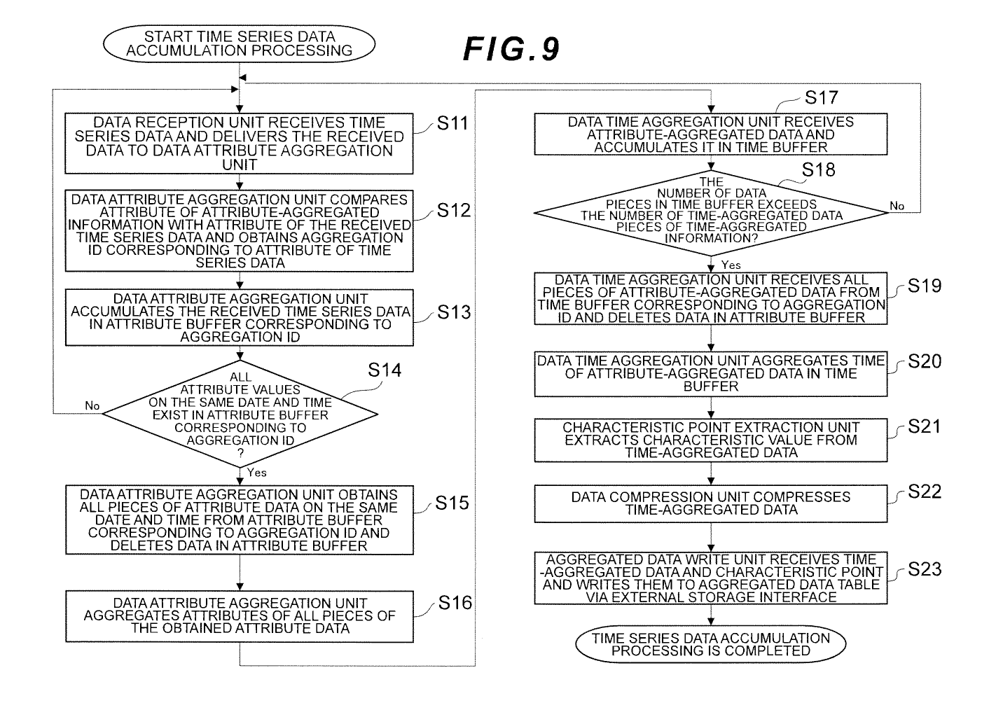

Next, the time series data accumulation processing will be explained in accordance with a flowchart of FIG. 9.

This processing is started by activation of the data accumulation unit 34 of the time series data processing program 30 by the processor 26.

Firstly, when the data reception unit 42 receives time series data from the time series data source 10 via the communications interface 22, the data reception unit 42 sequentially delivers the received time series data to the data attribute aggregation unit 44 (S11).

Next, the data attribute aggregation unit 44 compares the attribute of a plurality of pieces of time series data in the same cycle among the received time series data, for example, “the predicted number of vibrations and the actual number of vibrations” with the attribute 122 of the attribute-aggregated information 90; and if the attribute of each piece of the received time series data is the “predicted number of vibrations” or the “actual number of vibrations,” the data attribute aggregation unit 44 obtains the “number of vibrations” as the aggregation ID corresponding to the attribute of each piece of the received time series data (S12) and accumulates each piece of the received time series data in the attribute buffer 54 corresponding to the aggregation ID (the number of vibrations) (S13).

Next, the data attribute aggregation unit 44 judges whether all attribute values on the same date and time exist in the attribute buffer 54 corresponding to the aggregation ID or not (S14); and if all the attribute values do not exist, the data attribute aggregation unit 44 returns to the processing in step S11; and if it is determined that all the attribute values exist, the data attribute aggregation unit 44 obtains data of all the attributes on the same date and time from the attribute buffer 54 corresponding to the aggregation ID and then deletes the data in the attribute buffer 54 (S15).

Next, the data attribute aggregation unit 44: performs attribute aggregation to combines the data of all the attributes obtained from the attribute buffer 54 for each of the plural pieces of time series data which become the analysis targets and associate them with the aggregation ID; processes the combined plural pieces of the time series data as attribute-aggregated data; and outputs these attribute-aggregated data to the data time aggregation unit 46 (S16).

Next, the data time aggregation unit 46 receives the attribute-aggregated data and accumulates these attribute-aggregated data in the time buffer 56 (S17), and judges whether or not the number of data pieces of the time buffer 56 exceeds the number of pieces stored in the number of time-aggregated data pieces 42 of the time-aggregated information 92, for example, 3600 pieces (S18); and if the number of data pieces of the time buffer 56 does not exceed the number of time-aggregated data pieces, the data time aggregation unit 46 returns to the processing in step S11 in order to collect data for one hour; and if the number of data pieces of the time buffer 56 exceeds the number of time-aggregated data pieces, the data time aggregation unit 46 proceeds to processing in step S19, recognizing that the data for one hour has been collected.

Next, in step S19, the data time aggregation unit 46 obtains all pieces of the attribute-aggregated data from the time buffer 56 corresponding to the aggregation ID (the number of vibrations) and then deletes the data in the time buffer 56.

Next, the data time aggregation unit 46 aggregates time of all the pieces of the collected attribute-aggregated data as data for one hour, processes the attribute-aggregated data as time-aggregated data, and outputs the time-aggregated data to the characteristic point extraction unit 48 (S20).

Next, the characteristic point extraction unit 48 extracts “characteristic points” as its characteristic values from the input time-aggregated data and outputs the time-aggregated data together with the characteristic points to the data compression unit 50 (S21).

Next, the data compression unit 50 compresses the input time-aggregated data and outputs the compressed data and the characteristic points to the aggregated data write unit 52 (S22).

Next, the aggregated data write unit 52 receives the time-aggregated data and data of the characteristic point, writes the received time-aggregated data and characteristic point data to the aggregated data table 32 of the external storage device 18 via the external storage interface 24 (S23), and terminates the processing in this routine.

Under this circumstance, the aggregated data table 32 stores the hourly-based time-aggregated data together with the data of the characteristic points and the data aggregation time zone by associating them with the aggregation ID (the number of vibrations). Furthermore, since the compressed data are accumulated in the aggregated data table 32, the aggregated data can be accumulated in a smaller data amount than the amount of data which are not compressed.

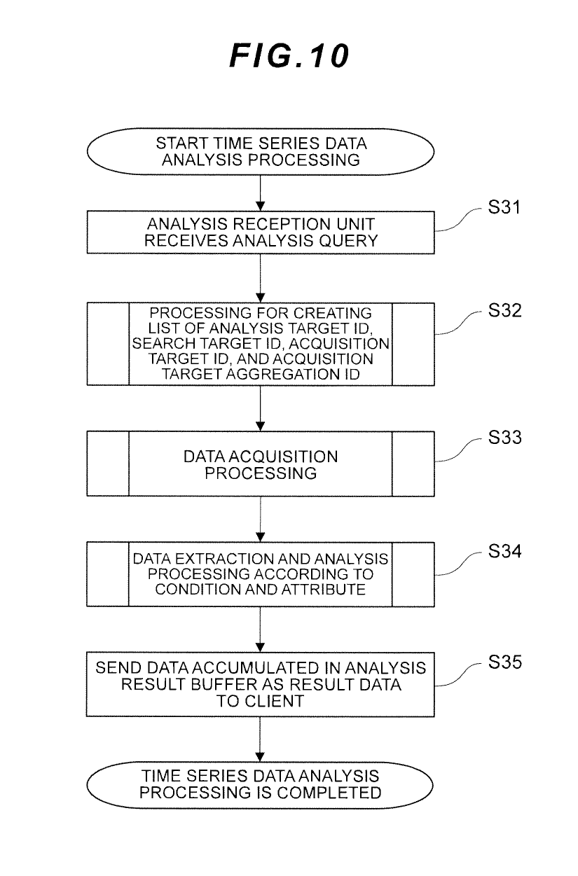

Next, the time series data analysis processing will be explained in accordance with a flowchart of FIG. 10.

This processing is started by activation of the data analysis unit 36 and the data acquisition unit 38 of the time series data processing program 30 by the processor 26.

Firstly, the analysis reception unit 60 receives the analysis query 170 (S31); the data acquisition unit 38 executes processing for creating lists of the analysis target ID, the search target ID, the acquisition target ID, and the acquisition target aggregation ID (S32); and then, the data acquisition unit 38 executes data acquisition processing (S33). Subsequently, the analysis execution unit 62 executes data extraction and analysis processing according to a condition and an attribute (S34), executes processing for sending data accumulated in an analysis result buffer (not shown) as result data to the client computer 12 (S35), and terminates the processing in this routine.

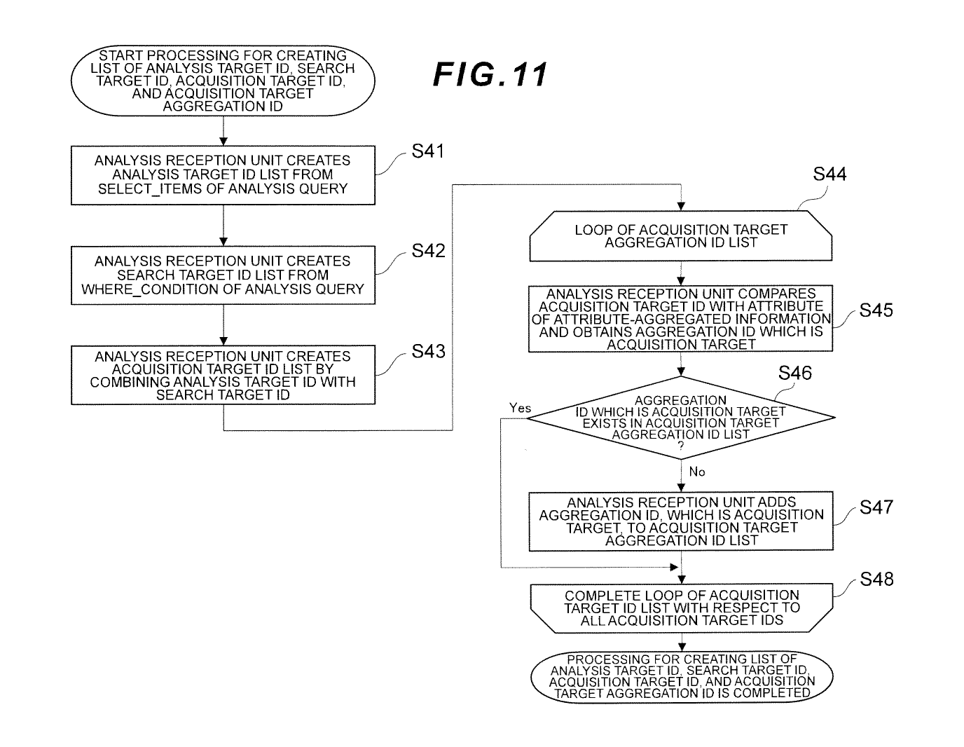

Next, the processing for creating the lists of the analysis target ID, the search target ID, the acquisition target ID, and the acquisition target aggregation ID will be explained in accordance with a flowchart in FIG. 11.

This processing is the processing executed in step S32 in FIG. 10; and the analysis reception unit 60 firstly creates an analysis target ID list from the selected items (select_items) 174 of the analysis query 70 and writes the predicted number of vibrations and the actual number of vibrations as the analysis target ID in this list (S41).

Next, the analysis reception unit 60 creates a search target ID list from the search condition (where_condition) 178 of the analysis query 170 and writes the predicted number of vibrations as the search target ID in this list (S42).

Then, the analysis reception unit 60 creates an acquisition target ID list by combining the analysis target ID and the search target ID and writes the predicted number of vibrations and the actual number of vibrations as the acquisition target ID in this list (S43).

Next, the analysis reception unit 60 starts loop processing of the acquisition target ID list from step S44 to step S48.

Firstly, the data analysis reception unit 60: compares the acquisition target ID with the attribute 122 of the attribute-aggregated information 90 and obtains the “number of vibrations” as the aggregation ID which becomes an acquisition target (S45); and judges whether or not the “number of vibrations” which is the aggregation ID and becomes the acquisition target exists in the acquisition target aggregation ID list (S46). If the “number of vibrations” does not exist, the data analysis reception unit 60 adds the aggregation ID which becomes the acquisition target to the acquisition target aggregation ID list (S47); and if the aggregation ID which becomes the acquisition target already exists in the acquisition target aggregation ID list, the data analysis reception unit 60 terminates the processing in this routine.

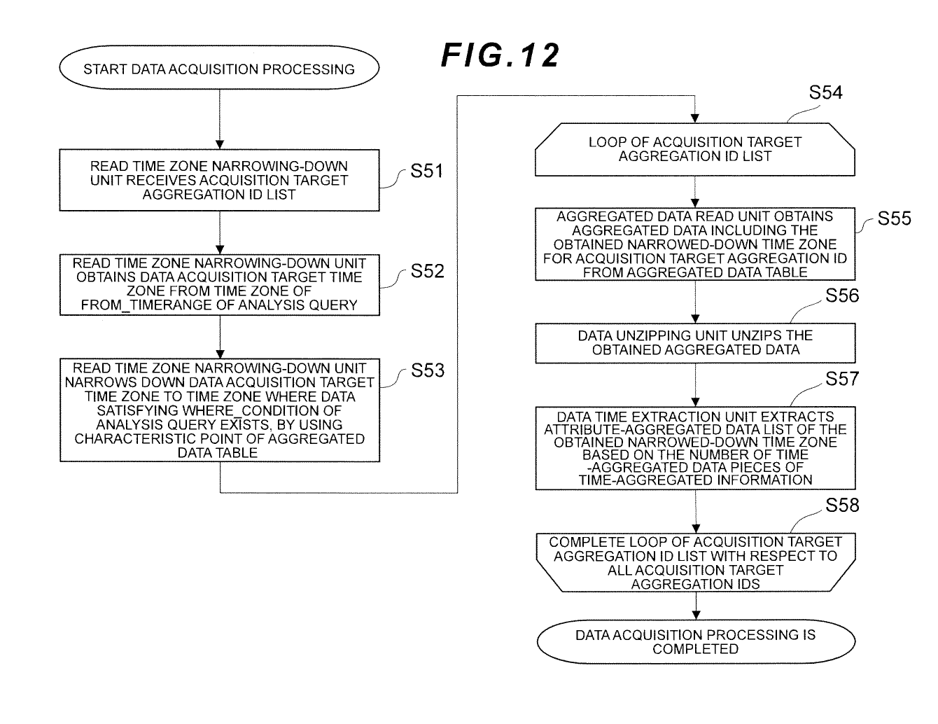

Next, the data acquisition processing will be explained in accordance with a flowchart in FIG. 12.

This processing is the processing executed in step S33 in FIG. 10. Firstly, the read time zone narrowing-down unit 70 receives the acquisition target aggregation ID list from the analysis reception unit 60 (S51) and obtains, for example, “07:20:00 to 08:40:00” as a data acquisition target time zone from a time zone of the data acquisition target time zone (from_timerange) 176 of the analysis query 170 based on the analysis query 170 (S52).

Next, the read time zone narrowing-down unit 270 narrows down the data acquisition time zone to a time zone where data satisfying the search condition (where_condition) 178 of the analysis query 170 exists, by using the characteristic points of the aggregated data table 32 (S53). For example, when the read time zone narrowing-down unit 270 refers to the aggregated data table 32 in FIG. 7 and if time series data whose predicted number of vibrations is 40 or more does not exist in a first entry, but exists in only a second entry, the read time zone narrowing-down unit 270 narrows down the data acquisition target time zone from 7:20 to 8:40 to 8:00 to 8:40.

Subsequently, the read time zone narrowing-down unit 70 outputs information about the narrowed-down data acquisition target time zone to the aggregated data read unit 72.

Subsequently, from step S54 to S58, loop processing of the acquisition target aggregation ID list is executed.

Firstly, the aggregated data read unit 72 refers to the aggregated data table 32, obtains aggregated data belonging to the narrowed-down data acquisition target time zone as aggregated data relating to the acquisition target aggregation ID from the aggregated data table 32, and outputs the obtained aggregated data to the data unzipping unit 74 (S55).

Next, the data unzipping unit 74 unzips the input aggregated data and outputs the unzipped aggregated data to the data time extraction unit 76 (S56).

Then, the data time extraction unit 76 refers to the number of time-aggregated data pieces 42 of the time-aggregated information 92 and extracts an attribute-aggregated data list belonging to the narrowed-down data acquisition target time zone based on the number of time-aggregated data pieces (S57); and on condition that the entire processing regarding the acquisition target aggregation ID list is completed, the data time extraction unit 76 terminates the processing in this routine.

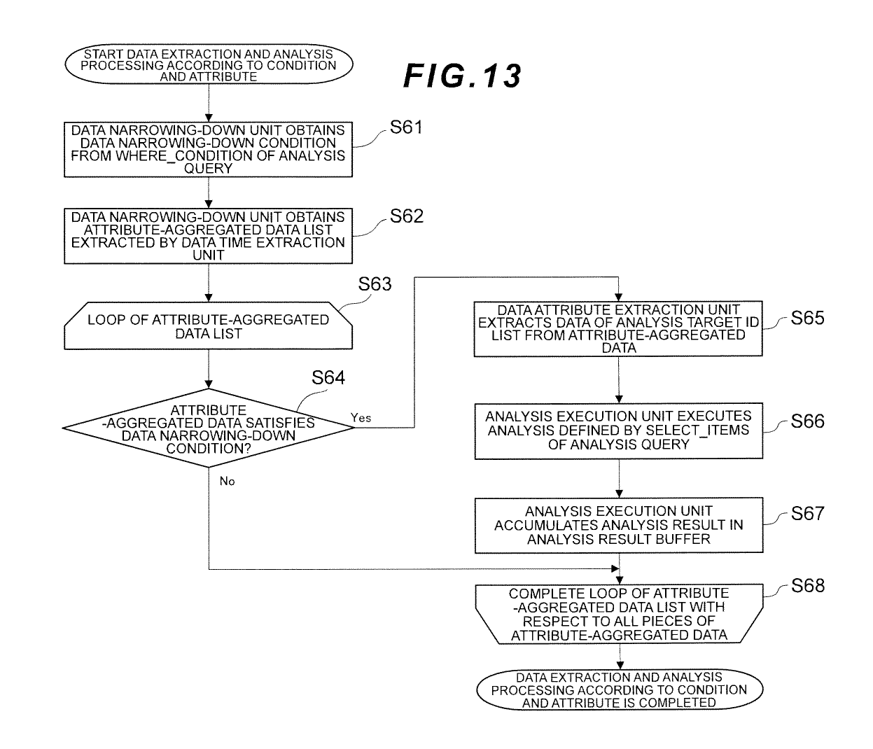

Next, the data extraction and analysis processing according to the condition and the attribute will be explained in accordance with a flowchart in FIG. 13.

This processing is the processing in step S34 in FIG. 10. Firstly, the data narrowing-down unit 78 obtains the data narrowing-down condition (the predicted number of vibrations is 40 or more) from the condition 178 of the analysis query 170 (S61) and obtains the attribute-aggregated data list extracted by the data time extraction unit 76 (S62).

Subsequently, from step S63 to S68, loop processing of the attribute-aggregated data list is executed.

Firstly, the data narrowing-down unit 78 judges whether the attribute-aggregated data satisfies the data narrowing-down condition or not (S64). Specifically speaking, the data narrowing-down unit 78 judges whether or not any data whose predicted number of vibrations is 40 or more exist in the attribute-aggregated data. In other words, the data narrowing-down unit 78 judges whether or not the value of the predicted number of vibrations is equal to the reference value=40 or more which becomes a condition of the search target. If any data whose predicted number of vibrations is 40 or more exist in the attribute-aggregated data, the data narrowing-down unit 78 extracts combinations of the time series data, regarding which the value of the predicted number of vibrations is equal to the reference value=40 or more which becomes the condition of the search target, as combinations of the narrowed-down time series data.

If any data whose predicted number of vibrations is 40 or more exist in the attribute-aggregated data, the data attribute extraction unit 78 extracts data of the analysis target ID list from the combinations of the time series data (attribute-aggregated data) narrowed down by the data narrowing-down unit 78 (S65). Specifically speaking, the data attribute extraction unit 78 extracts sets of the time series data relating to the predicted number of vibrations and the actual number of vibrations, which are specified by the selected items 174 of the analysis query 170, one set at a time as a plurality of pieces of time series data which are the analysis targets, from the attribute-aggregated data.

The data attribute extraction unit 80 outputs each combination of the plural pieces of the extracted time series data as the plurality of pieces of time series data, which are the analysis targets, to the analysis execution unit 62.

The analysis execution unit 62 analyzes the plural sets of the time series data extracted by the data attribute extraction unit 80 as specified by the selected items 174 of the analysis query 170 (S66). Specifically speaking, the analysis execution unit 62 analyzes on the sets of the plural pieces of time series data which become the analysis targets and whose predicted number of vibrations is 40 or more to find the divergence frequency by subtracting the actual number of vibrations from the predicted number of vibrations.

Subsequently, the analysis execution unit 62 accumulates each set of the analysis results in the analysis result buffer (not shown) (S67) and terminates the processing in this routine.

According to this embodiment, a plurality of pieces of time series data generated in the same cycle are gathered and aggregated based on the attribute (the number of vibrations) and also gathered and aggregated on the set time basis, so that the plurality of pieces of time series data generated in the same cycle can be accumulated efficiently.

Furthermore, according to this embodiment, combinations of the time series data generated in the same cycle are extracted as the time series data to be used for analysis from the aggregated data table 32 by accessing the aggregated data table 32, in which the plurality of pieces of time series data are accumulated based on the attribute (the number of vibrations), based on the attribute, so that the time series data used for the analysis can be efficiently accessed and analyzed.

### Embodiment 2

This embodiment is designed so that: upon data accumulation, combinations of time series data generated in different cycles (time series data relating to power generation and power consumption) are selected as combinations of a plurality of pieces of time series data, which become analysis targets, a plurality of sets of the selected combinations of the time series data are gathered and aggregated on a set time basis, and the plurality of aggregated sets of the time series data are accumulated in a storage unit by associating them with an attribute (electric power); and upon data analysis, the combinations of time series data generated in the different cycles (time series data relating to the power generation and the power consumption) are extracted, as time series data to be used for the analysis, from the storage unit.

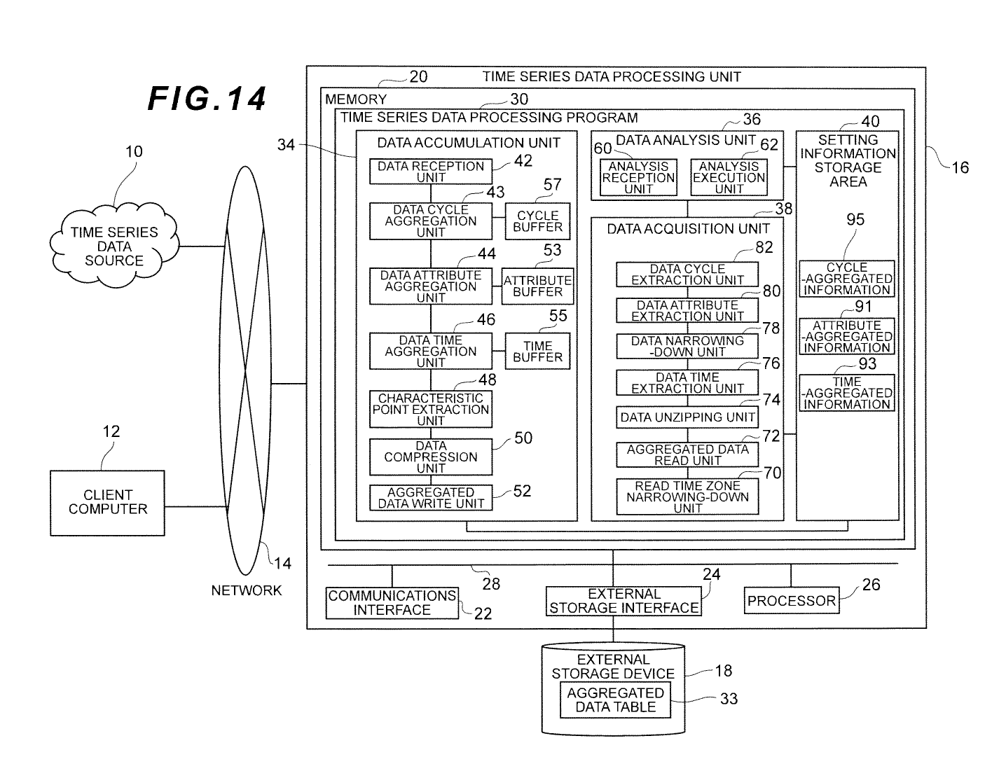

FIG. 14 shows the overall configuration of a second embodiment according to the present invention.

With the time series data processing unit 16 for a computer system according to this embodiment, a data cycle aggregation unit 43 is located between the data reception unit 42 and the data attribute aggregation unit 44 for the data accumulation unit 34, an attribute buffer 53 is located instead of the attribute buffer 54, a time buffer 55 is located instead of the time buffer 56, a cycle buffer 57 is located as a buffer managed by the data cycle aggregation unit 43, a data cycle extraction unit 82 is located after the data attribute extraction unit 80 for the data acquisition unit 38; in the setting information storage area 40, an attribute-aggregated information 91 is located instead of the attribute-aggregated information 90, time-aggregated information 93 is located instead of the time-aggregated information 92, and cycle-aggregated information 95 is newly located; and furthermore, in the external storage device 18, an aggregated data table 33 is stored instead of the aggregated data table 32; and the time series data processing unit 16 is designed to process time series data generated in different cycles as the time series data; and other components are the same as those in the first embodiment.

The data cycle aggregation unit 43 processes time series data whose generation cycles are different, among the time series data output from the data reception unit 42, by gathering them as time series data for one hour, so that for example, time series data generated in a one-hour cycle (time series data relating to the power generation) and time series data generated in a one-minute cycle (time series data relating to the power consumption) are accumulated as accumulated data in the cycle buffer 57 and each of the time series data generated in the one-hour cycle and the time series data generated in the one-minute cycle is output to the data attribute aggregation unit 44.

The data attribute aggregation unit 44: combines a plurality of pieces of time series data, which become analysis targets, that is, a plurality of pieces of time series data generated in different cycles, among the time series data which have been input; combines the combined plural pieces of time series data, for example, the time series data relating to the power generation and the timer series data relating to the power consumption; aggregates the combined plural pieces of time series data by associating them with a mutually related attribute, for example, electric power (hereinafter sometimes referred to as attribute aggregation); and accumulates the aggregated time series data as attribute-aggregated data in the attribute buffer 53 and outputs them to the data time aggregation unit 46.

The data time aggregation unit 46 collects the attribute-aggregated data, which have been input, only for a set time period and processes them as time-aggregated data. For example, the data time aggregation unit 46 aggregates the attribute-aggregated data, which have been input, on a 24-hour basis, accumulates them as time-aggregated data in the time buffer 55, and outputs them to the characteristic point extraction unit 48.

The characteristic point extraction unit 48 extracts characteristic points from the time-aggregated data, which have been input, and outputs the extracted characteristic points as well as the input time-aggregated data to the data compression unit 50.

The data compression unit 50 compresses the time-aggregated data, which have been output from the characteristic point extraction unit 48, and outputs the compressed data and the characteristic points, which have been output from the characteristic point extraction unit 48, to the aggregated data write unit 52.

The aggregated data write unit 52 writes the data, which have been output from the data compression unit 50, as aggregated data to the aggregated data table 32 of the external storage device 18.

In the same manner as in the first embodiment, the analysis reception unit 60 for the data analysis unit 36 receives an analysis query from the client computer 12 and outputs the received analysis query to the data acquisition unit 38. The analysis execution unit 62 executes analysis as specified by the analysis query based on the processing results of the data acquisition unit 38.

The read time zone narrowing-down unit 70, the aggregated data read unit 72, the data unzipping unit 74, the data time extraction unit 76, the data narrowing-down unit 78, and the data attribute extraction unit 80 for the data acquisition unit 38 execute processing relating to the time series data in the same manner as in the first embodiment.

Under this circumstance, the data attribute extraction unit 80: gathers and extracts combinations of time series data relating to one piece of power generation and time series data relating to 60 pieces of the power consumption for each analysis target as the plurality of pieces of time series data which become the analysis targets and whose aggregation ID is associated with the electric power, among the attribute-aggregated data narrowed down by the data narrowing-down unit 78; and outputs each of the plural pieces of the extracted time series data to the analysis execution unit 62.

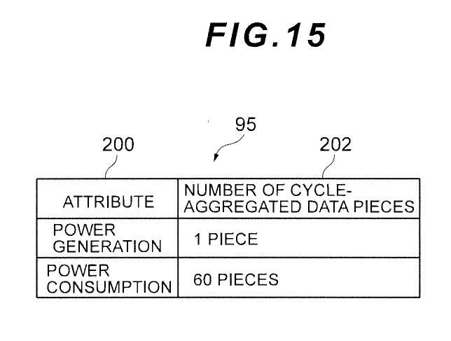

Next, FIG. 15 shows the structure of the cycle-aggregated information 95.

The cycle-aggregated information 95 is constituted from an attribute 200 and the number of cycle-aggregated data pieces 202. The attribute 200 stores, for example, “power generation” and “power consumption” as the attribute of the time series data which are the analysis targets. The number of cycle-aggregated data pieces 202 stores, for example, information indicating “one piece” corresponding to the power generation and “60 pieces” corresponding to the power consumption as the number of necessary data pieces when performing analysis on an hourly basis. This is because when analyzing the difference of electric power per hour, one piece of data is used as the power generation and 60 pieces of data are used as the power consumption for one minute.

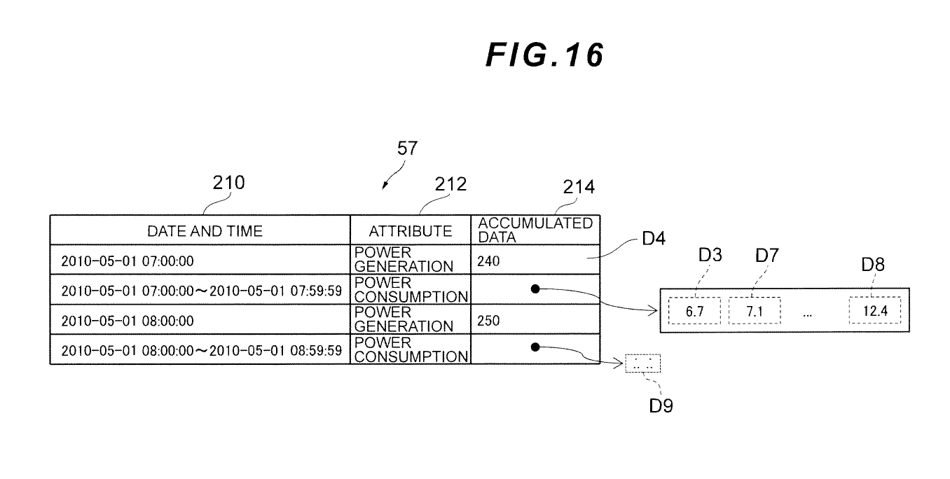

FIG. 16 shows the structure of the cycle buffer 57.

An information storage area of the cycle buffer 57 is configured in a table format and the table is constituted from a date and time field 210, an attribute field 212, and an accumulated data field 214.

Each entry of the date and time field 210 stores information about a data and time when accumulating data in the cycle buffer 57, as a numerical value together with the relevant date. Each entry of the attribute field 212 stores, for example, information indicating the “power generation” or the “power consumption” as the attribute of the time series data accumulated in the cycle buffer 57. Each entry of the accumulated data field 214 stores the value of the time series data (accumulated data) accumulated in the cycle buffer 57.

For example, “240” is stored as the value of the time series data D4 in FIG. 2 corresponding to the power generation and “6.7,” “7.1,” and “12.4” are stored as the values of the time series data D3, D7, D8 in FIG. 2 corresponding to the power consumption.

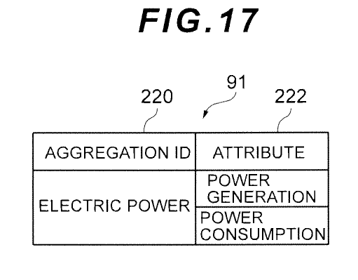

Next, FIG. 17 shows the structure of the attribute-aggregated information 91.

The attribute-aggregated information 91 is constituted from an aggregation ID 220 and an attribute 222. The attribute 222 stores, for example, “power generation” and “power consumption” as an attribute of time series data generated in different cycles. The aggregation ID 220 stores “electric power” as an attribute indicated by the power generation and the power consumption stored in the attribute 222 and as a mutually related attribute.

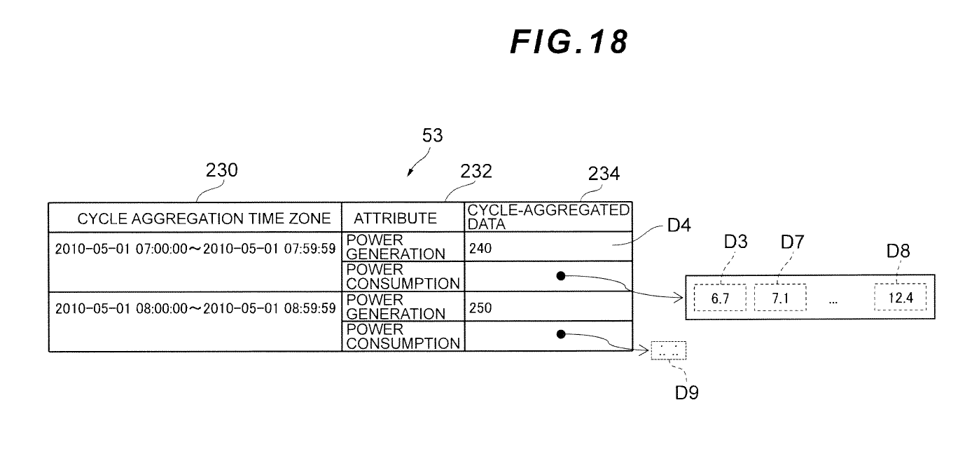

Next, FIG. 18 shows the structure of the attribute buffer 53.

An information storage area of the attribute buffer 53 is configured in a table format and the table is constituted from a cycle-aggregated time zone field 230, an attribute field 232, and a cycle-aggregated data field 234.

Each entry of the cycle-aggregated time zone field 230 stores information about a cycle-aggregated time zone on a hourly basis. Each entry of the attribute field 232 stores, for example, “power generation” and “power consumption” as the attribute of a plurality of pieces of time series data which become analysis targets.

Each entry of the cycle-aggregated data field 234 stores, for example, one value of the power generation corresponding to the power generation and 60 values of the power consumption collected in a one-minute cycle corresponding to the power consumption.

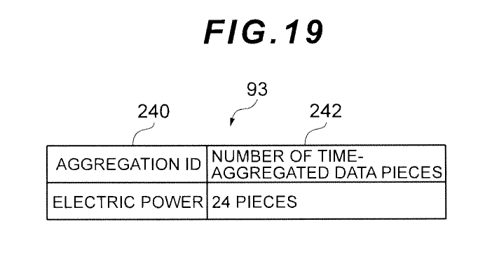

Next, FIG. 19 shows the structure of the time-aggregated information 93.

The time-aggregated information 93 is constituted from an aggregation ID 240 and the number of time-aggregated data pieces 242. The aggregation ID 240 stores, for example, “electric power” as an attribute mutually related to the “power generation” and the “power consumption”. The number of time-aggregated data pieces 242 stores, for example, “24 pieces” in order to aggregate time of electric power data on a 24-hour basis.

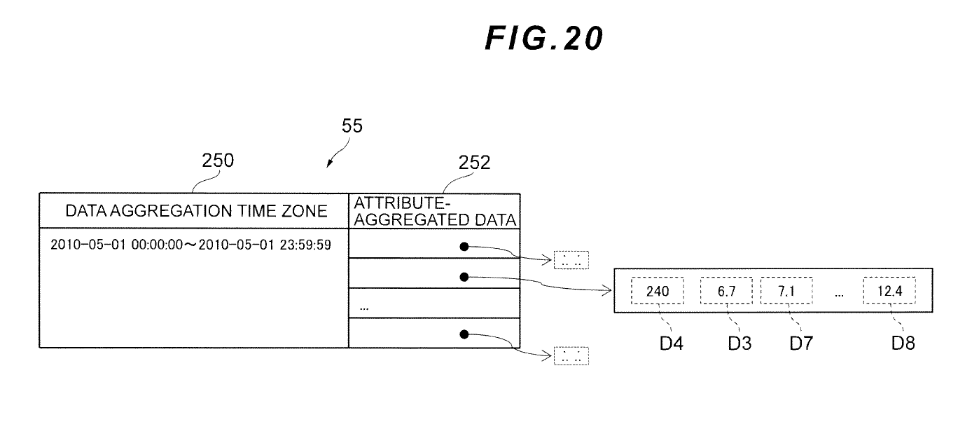

Next, FIG. 20 shows the structure of the time buffer 55.

The time buffer 55 is constituted from a data aggregation time zone 250 and attribute-aggregated data 252. The data aggregation time zone 250 stores information about a time zone to aggregate data as 24-hour based information. The attribute-aggregated data 252 stores data gathered for each hour. For example, in a case of the time series data in FIG. 2, the time series data D4, D3, D7, and so on up to D8 are stored as data for one hour, which become analysis targets.

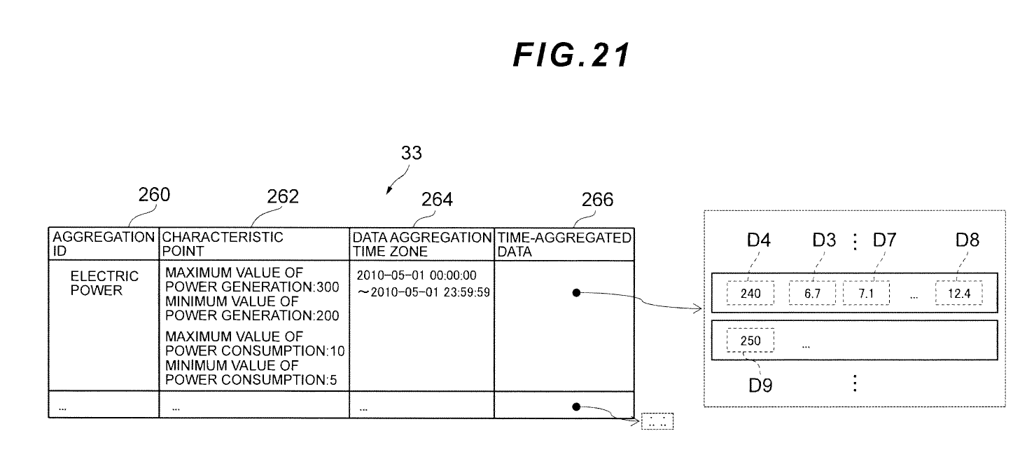

Next, FIG. 21 shows the structure of the aggregated data table 33.

An information storage area of the aggregated data table 33 is configured in a table format and the table is constituted from an aggregation ID field 260, a characteristic point field 262, a data aggregation time zone field 264, and a time-aggregated data field 266.

Each entry of the aggregation ID field 260 stores, for example, “electric power” as an attribute aggregating the power generation and the power consumption.

Each entry of the characteristic point field 262 stores information about characteristic points of time series collected every 24 hours. For example, a “maximum value of power generation: 300” is stored as a maximum value of the power generation and a “minimum value of power generation: 200” is stored as a minimum value of the power generation. Furthermore, a “maximum value of power consumption: 10” is stored as a maximum value of the power consumption and a “minimum value of power consumption: 5” is stored as a minimum value of the power consumption.

Each entry of the data aggregation time zone field 264 stores, for example, information about a data aggregation time zone to obtain the power generation and the power consumption for 24 hours.

The time-aggregated data field 266 stores a value related to cycle-aggregated data on an hourly basis as data for 24 hours. For example, in a case of the time series data in FIG. 2, respective values of the time series data D4, D3, D7, and so on up to D8 are stored as data for one hour.

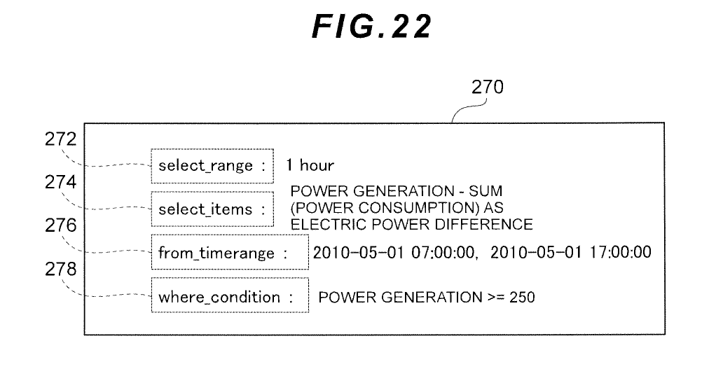

Next, FIG. 22 shows the structure of the analysis query 270.

The analysis query 270 is constituted from a selected range (select_range) 272, selected items (select_items) 274, a data acquisition target time zone (from_timerange) 276, and a search condition (where_condition) 278.

The selected range (select_range) 272 stores one hour as a processing time unit for the data analysis unit 36 to analyze data.

The selected items (select_items) 274 store, as an analysis target ID, for example, Power Generation—SUM (Power Consumption) AS Electric Power Difference.

The data acquisition target time zone (from_timerange) 276 stores, for example “2010-05-01 07:00:00” to “2010-05-01 17:00:00” as information about the data acquisition target time zone.

The condition (where_condition) 278 stores power generation >=250 as a condition to become the search target ID.

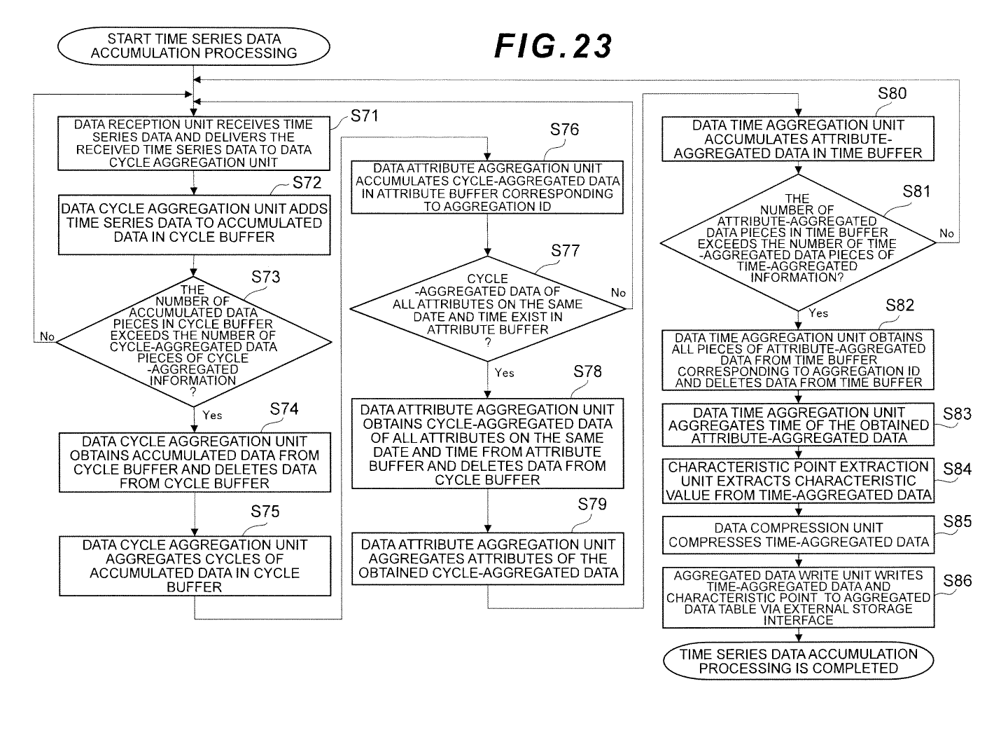

Next, the time series data accumulation processing will be explained in accordance with a flowchart in FIG. 23.

This processing is started by activation of the data accumulation unit 34 of the time series data processing program 30 by the processor 26.

Firstly, the data reception unit 42 receives the time series data, which have been output from the time series data source 10, via the network 14 and the communications interface 22 and delivers the received time series data to the data cycle aggregation unit 43 (S71).

Next, the data cycle aggregation unit 43 sequentially accumulates the input time series data in the cycle buffer 57 (S72) and judges whether or not the number of accumulated data pieces in the cycle buffer 57 exceeds the number specified by the number of cycle-aggregated data pieces 202 of the cycle-aggregated information 95 (S73); and if the number of data pieces accumulated in the cycle buffer 57 does not exceed the number of pieces specified by the number of cycle-aggregated data pieces 202, the data cycle aggregation unit 43 returns to the processing in step S71; and if the number of data pieces accumulated in the cycle buffer 57 exceeds the number of pieces specified by the number of cycle-aggregated data pieces 202, the data cycle aggregation unit 43 proceeds to processing in step S74.

In step S73, the data cycle aggregation unit 43: judges whether or not one piece of time series data relating to the power generation is accumulated during the process of sequentially accumulating the input time series data in the cycle buffer 57; and also judges whether or not the number of time series data pieces relating to the power consumption has reached 60 pieces.

Next, the data cycle aggregation unit 43: obtains the accumulated data accumulated in the cycle buffer 57 (data including one piece of the time series data relating to the power generation and 60 pieces of the time series data relating to the power consumption) from the cycle buffer 57 and then deletes the data from the cycle buffer 57 (S74); executes cycle aggregation to gather the accumulated data obtained from the cycle buffer 57 as data in a one-hour cycle and outputs the cycle-aggregated data on which the cycle aggregation was executed (data including the time series data relating to the power generation and the time series data relating to the power consumption) to the data attribute aggregation unit 44 (S75).

Next, the data attribute aggregation unit 44 receives the cycle-aggregated data and sequentially accumulates these cycle-aggregated data in the attribute buffer 53 corresponding to the aggregation ID (S76) and judges whether or not the cycle-aggregated data of all attributes (the power generation and the power consumption) on the same date and time exist in the attribute buffer 53 corresponding to the aggregation ID (S77); and if it is determined that the cycle-aggregated data of all the attributes on the same date and time do not exist, the data attribute aggregation unit 44 returns to the processing in step S71; and if it is determined that the cycle-aggregated data of all the attributes on the same date and time exist, the data attribute aggregation unit 44 obtains the cycle-aggregated data of all the attributes (the power generation and the power consumption) on the same date and time from the attribute buffer 53 corresponding to the aggregation ID and then deletes the data from the attribute buffer 53 (S78).

Next, the data attribute aggregation unit 44 combines the cycle-aggregated data of all the attributes (the power generation and the power consumption) on the same date and time, which are obtained from the attribute buffer 53, for each of the plural pieces of time series data which become the analysis targets, performs attribute aggregation to associate the cycle-aggregated data with the aggregation ID (electric power), processes the combined plural pieces of the time series data as attribute-aggregated data, and outputs these attribute-aggregated data to the data time aggregation unit 46 (S79).

Next, the data time aggregation unit 46 receives the attribute-aggregated data and sequentially accumulates these attribute-aggregated data in the time buffer 55 (S80), and judges whether the number of the attribute-aggregated data pieces accumulated in the time buffer 55 exceeds the number of pieces stored in the number of time-aggregated data pieces 242 of the time-aggregated information 93, for example, 24 pieces (S81); and if the number of the attribute-aggregated data pieces in the time buffer 55 does not exceed the number of time-aggregated data pieces, the data time aggregation unit 46 returns to the processing in step S71 to collect the attribute-aggregated data for 24 hours; and if the number of the attribute-aggregated data pieces in the time buffer 55 exceeds the number of time-aggregated data pieces, the data time aggregation unit 46 proceeds to processing in step S82, recognizing that the attribute-aggregated data for 24 hours have been collected.

Next, in step S82, the data time aggregation unit 46 obtains all pieces of the attribute-aggregated data from the time buffer 55 corresponding to the aggregation ID (electric power) and then deletes the data (attribute-aggregated data) from the time buffer 55.

Next, the data time aggregation unit 46 executes time aggregation to gather all the pieces of the obtained attribute-aggregated data as data for 24 hours, processes the attribute-aggregated data, on which the time aggregation was executed, as time-aggregated data, and outputs the time-aggregated data to the characteristic point extraction unit 48 (S83).

Next, the characteristic point extraction unit 48 extracts “characteristic points” as its characteristic value from the input time-aggregated data and outputs the time-aggregated data together with the extracted characteristic points to the data compression unit 50 (S84).

Next, the data compression unit 50 compresses the input time-aggregated data and outputs the compressed data and the characteristic points to the aggregated data write unit 52 (S85).

Next, the aggregated data write unit 52 receives the time-aggregated data and data of the characteristic point, writes the received time-aggregated data and characteristic point data to the aggregated data table 33 of the external storage device 18 via the external storage interface 24 (S86), and terminates the processing in this routine. Under this circumstance, the aggregated data table 33 stores the 24-hour based time-aggregated data together with the characteristic points and data of the data aggregation time zone by associating them with the aggregation ID (electric power).

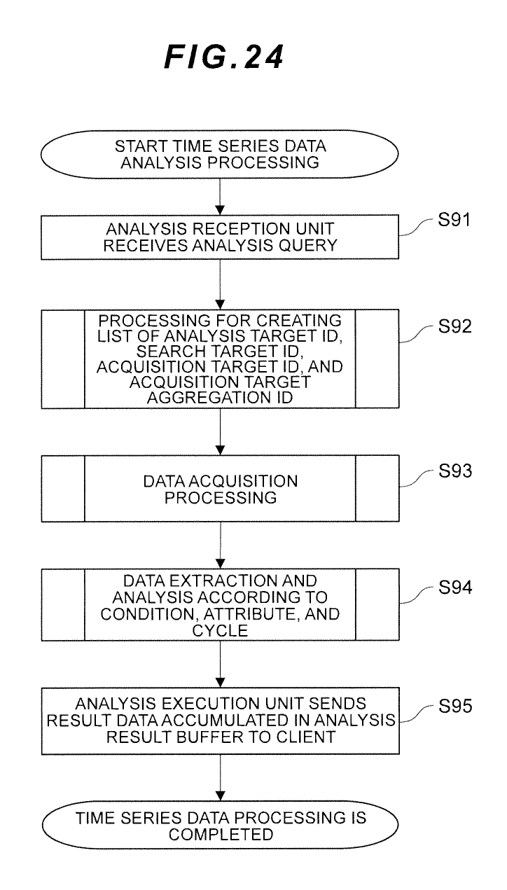

Next, the time series data analysis processing will be explained in accordance with a flowchart in FIG. 24.

This processing is executed by the data analysis unit 36 and the data acquisition unit 38. Firstly, the analysis reception unit 60 receives the analysis query 270 issued from the client computer 12 (S91); and then, the data acquisition unit 38 executes processing for creating lists of the acquisition target ID, the search condition ID, the acquisition target ID, and the acquisition target aggregation ID (S92).

Next, the data acquisition unit 38 executes data acquisition processing (S93); then, the analysis execution unit 62 executes data extraction and analysis processing according to a condition, an attribute, and a cycle (S94); and lastly, the analysis execution unit 62 sends result data accumulated in the analysis result buffer to the client computer 12 (S95) and terminates the processing in this routine.

Incidentally, the content of the processing for creating the lists of the acquisition target ID, the search condition ID, the acquisition target ID, and the acquisition target aggregation ID in step S92 is the same as that of the processing in FIG. 11, except that it is processing based on the analysis query 270; and furthermore, the content of the data acquisition processing in step S93 is the same as that of the processing in FIG. 12, except that it is based on the analysis query 270. Therefore, an explanation about them has been omitted.

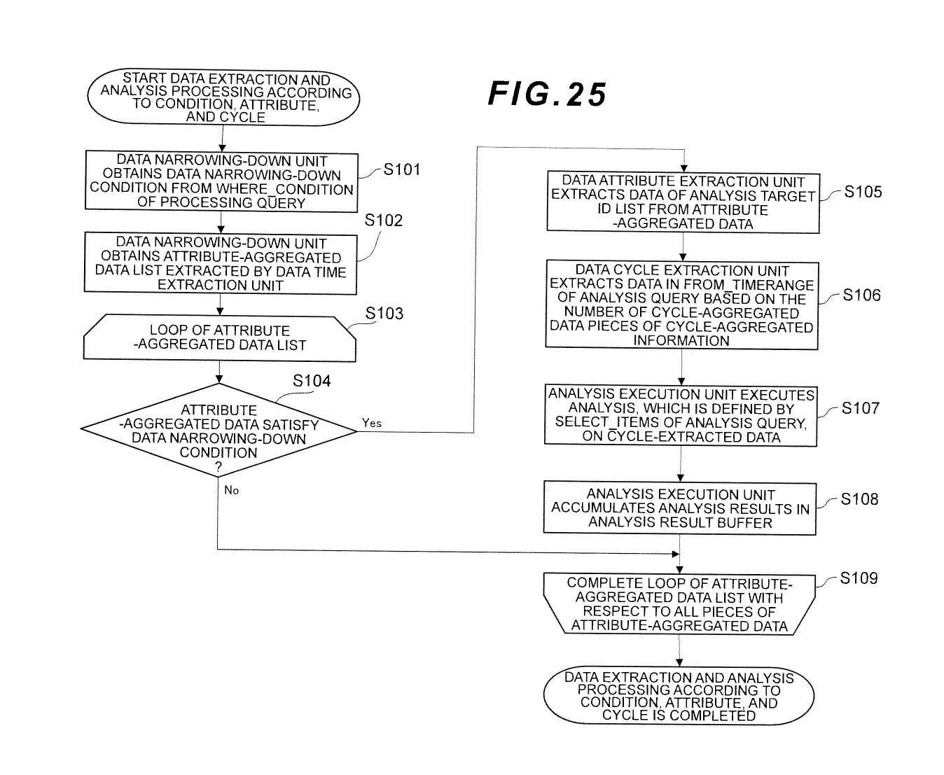

Next, the data extraction and analysis processing according to the condition, attribute, and cycle will be explained in accordance with a flowchart in FIG. 25.

This step is the processing executed in step S94 in FIG. 24. Firstly, if the data narrowing-down condition is set so that, for example, the power generation is equal to a reference value=250 or more, the data narrowing-down unit 78 obtains the power generation 250 or more from the search condition (where_condition) 278 of the analysis query 270 (S101) and then obtains the attribute-aggregated data list extracted by the data time extraction unit 76 (S102).

Subsequently, loop processing based on the attribute-aggregated data list is executed from step S103 to S109.

Firstly, the data narrowing-down unit 78 judges whether the obtained attribute-aggregated data satisfy the data narrowing-down condition or not (S104). Specifically speaking, the data narrowing-down unit 78 judges whether or not any data whose power generation is 250 or more exist in the attribute-aggregated data; and if any data whose power generation is 250 or more exist in the attribute-aggregated data, the data narrowing-down unit 78 proceeds to step S105; and if any data whose power generation is 250 or more do not exist in the attribute-aggregated data, the data narrowing-down unit 78 proceeds to processing in step S109.

In step S105, the data attribute extraction unit 80 extracts the attribute-aggregated data of the analysis target ID list from the attribute-aggregated data. Specifically speaking, the data attribute extraction unit 80 extracts the attribute-aggregated data specified in the selected items 274 of the analysis query 270, for example, attribute-aggregated data including one piece of the time series data relating to the power generation and 60 pieces of the time series data relating to the power consumption as data for one hour.

Next, the data cycle extraction unit 82 extracts data (data accumulated during a period from 7:00:00 to 17:00:00) within the data acquisition target time zone (from_timerange) 276 of the analysis query 270 based on the number of data pieces specified by the number of cycle-aggregated data pieces 202 of the cycle-aggregated information 95 (power generation: 1 piece; and power consumption: 60 pieces) (S 106).

Subsequently, the analysis execution unit 62 analyzes the data extracted by the data cycle extraction unit 82 with respect to the selected items (select_items) 274 of the analysis query 270. For example, if the selected items (select_items) 274 are “Power Generation—SUM (Power Consumption) AS Electric Power Difference,” the analysis execution unit 62 executes an operation to calculate the electric power difference by subtracting the power consumption for one hour from the power generation.

Next, the analysis execution unit 62 accumulates the analysis results in an analysis result buffer (not shown) (S108); and on condition that the execution of the entire processing on the attribute-aggregated data list is completed, the analysis execution unit 62 terminates the processing in this routine.

According to this embodiment, a plurality of pieces of time series data generated in different cycles are gathered and aggregated based on the attribute (electric power) and also gathered and aggregated on a set time basis, so that the plurality of pieces of time series data generated in the different cycles can be accumulated efficiently.

Furthermore, according to this embodiment, combinations of the time series data generated in the different cycles are extracted as the time series data to be used for analysis from the aggregated data table 33, in which the plurality of pieces of time series data are accumulated based on the attribute (electric power), by accessing the aggregated data table 33 based on the attribute. So, the plurality of pieces of time series data used for the analysis can be efficiently accessed and analyzed.

### REFERENCE SIGNS LIST

10 time series data source, 12 client computer, 14 network, 16 time series data processing unit, 18 external storage device, 20 memory, 26 processor, 30 time series data processing program, 32 aggregated data table, 34 data accumulation unit, 36 data analysis unit, 38 data acquisition unit, 40 setting information storage area, 42 data reception unit, 43 data cycle aggregation unit, 44 data attribute aggregation unit, 46 data time aggregation unit, 48 characteristic point extraction unit, 50 data compression unit, 52 aggregated data write unit, 60 analysis reception unit, 62 analysis execution unit, 70 read time zone narrowing-down unit, 72 aggregated data read unit, 74 data unzipping unit, 76 data time extraction unit, 78 data narrowing-down unit, 80 data attribute extraction unit, and 82 data cycle extraction unit.

1. A time series data processing unit comprising a data processing unit for sequentially inputting and processing time series data from a time series data generation source, a storage unit for accumulating a processing result of the data processing unit, and a data acquisition analysis unit for obtaining data from the storage unit and analyzing the obtained data according to an analysis request,
wherein the data processing unit combines a plurality of pieces of time series data, which become analysis targets, among the time series data, which have been input, and accumulates the combined plural pieces of time series data in the storage unit by associating them with a mutually related attribute; and
wherein if a search target specified by the analysis request is the attribute, the data acquisition analysis unit accesses the storage unit by using the attribute as the search target, extracts the plurality of pieces of time series data, which are time series data corresponding to the attribute and become the analysis targets, from the storage unit, and executes analysis as specified by the analysis request by using the extracted plural pieces of time series data.

2. The time series data processing unit according to claim 1,
wherein the data processing unit selects combinations of the time series data generated in a same cycle as combinations of the plurality of pieces of time series data, which become the analysis targets, gathers and aggregates plural sets of the selected combinations of time series data on a set time basis, and accumulates the aggregated plural sets of time series data in the storage unit by associating them with the attribute; and
wherein the data acquisition analysis unit extracts the combinations of time series data generated in the same cycle as time series data to be used for the analysis from the storage unit.

3. The time series data processing unit according to claim 1,
wherein the data processing unit selects combinations of the time series data generated in the same cycle as combinations of the plurality of pieces of time series data, which become the analysis targets, and accumulates the selected combinations of time series data in the storage unit by associating them with the attribute; and
wherein the data acquisition analysis unit extracts the combinations of time series data generated in the same cycle as time series data to be used for the analysis from the storage unit.

4. The time series data processing unit according to claim 1,
wherein the data processing unit selects combinations of the time series data generated in different cycles as combinations of the plurality of pieces of time series data, which become the analysis targets, and accumulates the selected combinations of time series data in the storage unit by associating them with the attribute; and
wherein the data acquisition analysis unit extracts the combinations of time series data generated in the different cycles as time series data to be used for the analysis from the storage unit.

5. The time series data processing unit according to claim 3,
wherein the data processing unit gathers and aggregates plural sets of the selected combinations of time series data on a set time basis and accumulates the aggregated plural sets of time series data in the storage unit by associating them with the attribute; and
wherein the data acquisition analysis unit extracts the aggregated plural sets of time series data as time series data to be used for the analysis from the storage unit.

6. The time series data processing unit according to claim 4,
wherein the data processing unit gathers and aggregates plural sets of the selected combinations of time series data on a set time basis and accumulates the aggregated plural sets of time series data in the storage unit by associating them with the attribute; and
wherein the data acquisition analysis unit extracts the aggregated plural sets of time series data as time series data to be used for the analysis from the storage unit.

7. The time series data processing unit according to claim 1,
wherein the data processing unit selects combinations of the time series data generated in the same cycle as combinations of the plurality of pieces of time series data, which become the analysis targets, extracts a characteristic point of each piece of the time series data belonging to the selected combinations of time series data, and accumulates the selected combinations of time series data together with the extracted characteristic point in the storage unit by associating them with the attribute; and
wherein if a reference value for the characteristic point of the time series data belonging to the combinations of time series data generated in the same cycle is specified by the analysis query as a condition of the search target, the data acquisition analysis unit extracts the time series data, whose characteristic point satisfies the reference value, as the time series data to be used for the analysis among the combinations of time series data generated in the same cycle from the storage unit.

8. The time series data processing unit according to claim 1,
wherein the data processing unit selects combinations of the time series data generated in different cycles as combinations of the plurality of pieces of time series data, which become the analysis targets, extracts a characteristic point of each piece of the time series data belonging to the selected combinations of time series data, and accumulates the selected combinations of time series data together with the extracted characteristic point in the storage unit by associating them with the attribute; and
wherein if a reference value for the characteristic point of the time series data belonging to the combinations of time series data generated in the different cycles is specified by the analysis query as a condition of the search target, the data acquisition analysis unit extracts the time series data, whose characteristic point satisfies the reference value, as the time series data to be used for the analysis among the combinations of time series data generated in the different cycles from the storage unit.

9. The time series data processing unit according to claim 1,
wherein the data processing unit selects combinations of the time series data generated in the same cycle as combinations of the plurality of pieces of time series data, which become the analysis targets, compresses each piece of time series data belonging to the selected combinations of time series data, and accumulates the compressed combinations of time series data in the storage unit by associating them with the attribute; and
wherein the data acquisition analysis unit extracts the compressed combinations of time series data as time series data to be used for the analysis, among the combinations of time series data generated in the same cycle, from the storage unit and unzips each extracted piece of the time series data.

10. The time series data processing unit according to claim 1,
wherein the data processing unit selects combinations of the time series data generated in different cycles as combinations of the plurality of pieces of time series data, which become the analysis targets, compresses each piece of time series data belonging to the selected combinations of time series data, and accumulates the compressed combinations of time series data in the storage unit by associating them with the attribute; and
wherein the data acquisition analysis unit extracts the compressed combinations of time series data as time series data to be used for the analysis, among the combinations of time series data generated in the different cycles, from the storage unit and unzips each extracted piece of the time series data.

11. A time series data processing method comprising a data processing unit for sequentially inputting and processing time series data from a time series data generation source, a storage unit for accumulating a processing result of the data processing unit, and a data acquisition analysis unit for obtaining data from the storage unit and analyzing the obtained data according to an analysis request,
the time series data processing method comprising:
a step executed by the data processing unit combining a plurality of pieces of time series data, which become analysis targets, among the time series data, which have been input, and accumulating the combined plural pieces of time series data in the storage unit by associating them with a mutually related attribute;
a step executed, if a search target specified by the analysis request is the attribute, by the data acquisition analysis unit accessing the storage unit by using the attribute as the search target;
a step executed by the data acquisition analysis unit extracting the plurality of pieces of time series data, which are time series data corresponding to the attribute and become the analysis targets, from the storage unit; and
a step executed by the data acquisition analysis unit executing analysis specified by the analysis request by using the plural pieces of time series data extracted in the above step.

12. The time series data processing method according to claim 11, comprising:
a step executed by the data processing unit selecting combinations of the time series data generated in a same cycle as combinations of the plurality of pieces of time series data, which become the analysis targets;
a step executed by the data processing unit gathering and aggregating plural sets of the selected combinations of time series data on a set time basis;
a step executed by the data processing unit accumulating the plural sets of time series data aggregated in the above step in the storage unit by associating them with the attribute;
a step executed by the data acquisition analysis unit extracting the combinations of time series data generated in the same cycle as time series data to be used for the analysis from the storage unit.

13. The time series data processing method according to claim 11, comprising:
a step executed by the data processing unit selecting combinations of the time series data generated in the same cycle as combinations of the plurality of pieces of time series data, which become the analysis targets;
a step executed by the data processing unit accumulating the combinations of time series data selected in the above step in the storage unit by associating them with the attribute; and
a step executed by the data acquisition analysis unit extracting the combinations of time series data generated in the same cycle as time series data to be used for the analysis from the storage unit.

14. The time series data processing method according to claim 11, comprising:
a step executed by the data processing unit selecting combinations of the time series data generated in different cycles as combinations of the plurality of pieces of time series data, which become the analysis targets;
a step executed by the data processing unit accumulating the combinations of time series data selected in the above step in the storage unit by associating them with the attribute; and
a step executed by the data acquisition analysis unit extracting the combinations of time series data generated in the different cycles as time series data to be used for the analysis from the storage unit.

15. The time series data processing method according to claim 13, comprising:
a step executed by the data processing unit gathering and aggregating plural sets of the selected combinations of time series data on a set time basis;
a step executed by the data processing unit accumulating the plural sets of time series data aggregated in the above step in the storage unit by associating them with the attribute; and
a step executed by the data acquisition analysis unit extracting the plural sets of time series data aggregated in the above step as time series data to be used for the analysis from the storage unit.

16. The time series data processing method according to claim 14, comprising:
a step executed by the data processing unit gathering and aggregating plural sets of the selected combinations of time series data on a set time basis;
a step executed by the data processing unit accumulating the plural sets of time series data aggregated in the above step in the storage unit by associating them with the attribute; and
a step executed by the data acquisition analysis unit extracting the plural sets of time series data aggregated in the above step as time series data to be used for the analysis from the storage unit.

17. The time series data processing method according to claim 11, comprising:
a step executed by the data processing unit selecting combinations of the time series data generated in the same cycle as combinations of the plurality of pieces of time series data, which become the analysis targets;
a step executed by the data processing unit extracting a characteristic point of each piece of the time series data belonging to the combinations of time series data selected in the above step;
a step executed by the data processing unit accumulating the combinations of time series data selected in the above step together with the extracted characteristic point in the storage unit by associating them with the attribute; and
a step executed, if a reference value for the characteristic point of the time series data belonging to the combinations of time series data generated in the same cycle is specified by the analysis query as a condition of the search target, by the data acquisition analysis unit extracting the time series data, whose characteristic point satisfies the reference value, as the time series data to be used for the analysis among the combinations of time series data generated in the same cycle from the storage unit.

18. The time series data processing method according to claim 11, comprising:
a step executed by the data processing unit selecting combinations of the time series data generated in different cycles as combinations of the plurality of pieces of time series data, which become the analysis targets;
a step executed by the data processing unit extracting a characteristic point of each piece of the time series data belonging to the combinations of time series data selected in the above step;
a step executed by the data processing unit accumulating the combinations of time series data selected in the above step together with the extracted characteristic point in the storage unit by associating them with the attribute; and
a step executed, if a reference value for the characteristic point of the time series data belonging to the combinations of time series data generated in the different cycles is specified by the analysis query as a condition of the search target, by the data acquisition analysis unit extracting the time series data, whose characteristic point satisfies the reference value, as the time series data to be used for the analysis among the combinations of time series data generated in the different cycles from the storage unit.

19. The time series data processing method according to claim 11, comprising:
a step executed by the data processing unit selecting combinations of the time series data generated in the same cycle as combinations of the plurality of pieces of time series data, which become the analysis targets;
a step executed by the data processing unit compressing each piece of time series data belonging to the combinations of time series data selected in the above step; and
a step executed by the data processing unit accumulating the combinations of time series data compressed in the above step in the storage unit by associating them with the attribute;
a step executed by the data acquisition analysis unit extracting the compressed combinations of time series data as time series data to be used for the analysis, among the combinations of time series data generated in the same cycle, from the storage unit; and
a step executed by the data acquisition analysis unit unzipping each piece of the time series data extracted in the above step.

20. The time series data processing method according to claim 11, comprising:
a step executed by the data processing unit selecting combinations of the time series data generated in different cycles as combinations of the plurality of pieces of time series data, which become the analysis targets;
a step executed by the data processing unit compressing each piece of time series data belonging to the combinations of time series data selected in the above step; and
a step executed by the data processing unit accumulating the combinations of time series data compressed in the above step in the storage unit by associating them with the attribute;
a step executed by the data acquisition analysis unit extracting the compressed combinations of time series data as time series data to be used for the analysis, among the combinations of time series data generated in the different cycles, from the storage unit; and
a step executed by the data acquisition analysis unit unzipping each piece of the time series data extracted in the above step.
